(19) United States
(12) Patent Application Publication
(10) Pub. No.: US 2010/0096561 A1
(43) Pub. Date: Apr. 22, 2010

(54) METHODS AND SYSTEMS FOR DETECTION WITH FRONT IRRADIATION

(75) Inventors: Mark Thomas Johnson, Eindhoven (NL); Marc Wilhelmus Gijsbert Ponjee, Eindhoven (NL); Marcello Leonardo Mario Balistreri, Eindhoven (NL); Maarten Marinus Johannes Wilhelmus Van Herpen, Eindhoven (NL); Derk Jan Wilfred Klunder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/443,863

(22) PCT Filed: Oct. 3, 2007
(86) PCT No.: PCT/IB07/54022

§ 371 Date: Apr. 1, 2009

(30) Foreign Application Priority Data
Oct. 5, 2006 (EP) 06121789.9

(51) Int. Cl. G01N 21/01; G01J 1/58

(52) U.S. Cl. 250/459.1; 356/244

(57) ABSTRACT

A radiation detection system (100) is described comprising a measurement region (104) in a measurement chamber adapted for receiving at least one sample (108) to be examined and adapted for receiving excitation radiation for impingement on the at least one sample (108) and for generating sample radiation. The radiation detection system (100) furthermore comprises at least one detector element (106) for detection of the generated sample radiation. The radiation detection system thereby is a front irradiation system, i.e. the excitation radiation is incident on a first side of the measurement region (104) in a measurement chamber and the at least one detector element (106) is positioned at a second side of the measurement region (104) in a measurement chamber, the second side being opposite to the first side with respect to the measurement region (104) in a measurement chamber, such that detection occurs at the side facing the first side. The detection system (100) also comprises optical means (112) adapted for guiding said excitation radiation aside the at least one detector element (106).

### FIELD OF THE INVENTION

The present invention relates to the field of detection and to any devices which require detection means. More particularly, the present invention relates to the field of sensors and especially biosensor and/or micro-fluidic devices for chemical, biological and/or bio-chemical analysis of samples.

### BACKGROUND OF THE INVENTION

Micro-fluidic devices are at the heart of most biochip technologies, being used for both the preparation of fluidic, e.g. blood based, samples and their subsequent analysis. Integrated devices comprising biosensors and micro-fluidic devices are known, e.g. under the name DNA/RNA chips, BioChips, GeneChips and Lab-on-a-chip. In particular, high throughput screening on arrays, e.g. micro-arrays, is one of the new tools for chemical or biochemical analysis, for instance employed in diagnostics. These biochip devices comprise small volume wells or reactors, in which chemical or biochemical reactions are examined, and may regulate, transport, mix and store minute quantities of liquids rapidly and reliably to carry out desired physical, chemical, and biochemical reactions and analysis in large numbers. By carrying out assays in small volumes, significant savings can be achieved in time and in costs of targets, compounds and reagents.

Generally, detection of fluorescence signals of a biochip is done using an optical detection system, comprising a light-source, optical filters and sensors (e.g. CCD camera), localized in a bench-top/laboratory machine, to quantify the amount of fluorophores present. A schematic illustration of such a sensor 10 is indicated in FIG. 1, showing a radiation source 14, for irradiating a sample 16 on a substrate 18. The resulting fluorescence signals are collected using optics 22 in a detector element 12. The fluorescence detection systems used in bench-top/laboratory machines furthermore generally require expensive optical components to acquire and analyse the fluorescence signals. Typically a filter for filtering the excitation radiation 20 and a filter 24 for separating the excitation radiation from the fluorescence response is needed. In particular, expensive optical filters with sharp wavelength cut-off, i.e. filters that are highly selective, are used to obtain the needed sensitivity of these optical systems, as often the shift between the excitation spectrum (absorption) and emission spectrum (fluorescence) is small (<50 nm). The latter is illustrated in FIG. 2. Consequently, the main sources of noise in a fluorescence based optical system are reflection of (a part of) the excitation light and (Rayleigh) scattering of the excitation light.

In many biotechnological applications, such as molecular diagnostics, there is a need for biochips comprising an optical sensor, or an array of optical sensors, that detect fluorescence signals and can be read-out in parallel and independently to allow high throughput analysis under a variety of (reaction) conditions. Advantages of biochips incorporating the optical sensor are, among others that on-chip fluorescence signal acquisition system improves both the speed and the reliability of analysis chips, eg DNA chip hybridisation pattern analysis, that costs are reduced for assays, that high portability is obtained e.g. by obtaining portable hand-held instruments for applications such as point-of-care diagnostics and roadside testing (i.e. no central bench-top machine needed anymore), that the fluorescent intensity can be enlarged as the solid angle of collection increases and that the number of medium boundaries and corresponding reflections decreases.

A bench-top machine will become able to handle versatile biochips and a multiplicity of biochips. Having the optical sensor as part of the bench-top machine demands the mounting of a specific filter set for a specific assay, which hampers the parallel (multiplexed) detection of fluorescent labels with various excitation and/or emission spectra. Therefore, being able to read-out on-chip optical sensor(s) allows for a flexible multi-purpose bench-top machine and opens the route towards standardization of bio chips, bench-top machines, and components thereof. Nevertheless, the need for filters makes such biochips expensive, which is especially disadvantageous if disposable biochips are considered.

In Nucleic Acids Research 32 (2004), Fixe et al. describes a biochip with integrated optical sensors. The detection system uses an expensive filter for filtering out the excitation light, whereby the detection sensitivity is limited due to the filtering.

In numerous biotechnological applications, such as molecular diagnostics, there is a need for biochemical modules (e.g. sensors, PCR), comprising an array of temperature controlled compartments that can be processed in parallel and independently to allow high versatility and high throughput.

### SUMMARY OF THE INVENTION

It is an object of the present invention to provide efficient systems and methods for detection of radiation in a front irradiation system. It is an advantage of embodiments of the present invention that the high cost, both economical and labour intensive, of a high quality filter for splitting the excitation radiation and the generated sample radiation can be avoided. It furthermore is an advantage of embodiments of the present invention that a high sensitivity for generated sample radiation can be obtained. It is an advantage of embodiments of the present invention that efficient detection for a front irradiated system is obtained. The latter allows using a substrate for the detector that is not transparent such as a silicon wafer or a flexible metal foil. It is also an advantage of embodiments of the present invention that the direct irradiation of the sensor by excitation radiation can be suppressed, thus allowing detection of a, typically weaker, generated sample signal.

The above objective is accomplished by a method and device according to the present invention.

The present invention relates to a radiation detection system comprising a measurement region in a measurement chamber adapted for receiving at least one sample to be examined and for receiving excitation radiation for impingement on the at least one sample and for generating sample radiation, the radiation detection system also comprising at least one detector element for detection of the generated sample radiation, the excitation radiation being incident on a first side of the measurement region in a measurement chamber and the at least one detector element being positioned at a second side of the measurement region in a measurement chamber, the second side being opposite to the first side with respect to the measurement region in the measurement chamber, wherein the detection system furthermore comprises optical means adapted for guiding the excitation radiation aside the at least one detector element. It is an advantage of the present invention that selective filters for separating excitation radiation and resulting radiation may be avoided in embodiments according to the present invention. The latter results in a reduction of both the economical and labour-intensive cost. The resulting radiation may e.g. be any of fluorescence radiation, phosphorescence radiation, chemiluminescence radiation, photochromism radiation. The optical means furthermore may be adapted for guiding background radiation, e.g. stray light aside the at least one detector element.

The optical means may comprise shielding means adapted for substantially shielding the at least one detector element from the excitation radiation.

The shielding means may comprise a first shielding element adapted for substantially shielding direct impingement of excitation radiation on the at least one detector element. It is an advantage of particular embodiments that only few components are needed for obtaining a front-irradiated radiation detector. The first shielding element may be controllably moveable with respect to the at least one detector element.

The shielding means furthermore may comprise a second shielding element adapted for substantially blocking at least part of the excitation radiation scattered by the first shielding element.

It is an advantage of particular embodiments of the present invention that a high fluorescence sensitivity can be obtained.

At least one of the first and the second shielding element may be controllably moveable with respect to the at least one detector element.

The shielding means may comprise at least one shielding element that is controllably moveable with respect to said at least one detector element. The at least one shielding element that is controllably moveable may be the first shielding element. The at least one shielding element that is controllably moveable may be the second shielding element. The at least one shielding element that is controllably moveable also may be the first shielding element and the second shielding element.

The shielding element being controllably moveable may be moveable within a plane determined by the shielding element. With “plane determined by the shielding element” there is meant the plane in which the shielding element substantially extends.

The detection system may comprise a plurality of detector elements and furthermore may comprise a controller for correlating a movement of the controllably moveable shielding element with an activation of each of the plurality of detector elements. It is an advantage of embodiments of the present invention that indirect impingement of excitation radiation on the at least one detector element can be substantially reduced. The controller may synchronise switching of the plurality of detector elements and movement of the shielding element by turning ON each of the plurality of detector elements when they are substantially shielded of excitation radiation.

The shielding element being controllably moveable may be moveable in a direction perpendicular to a plane determined by the shielding element.

It is an advantage of particular embodiments of the present invention that the detection sensitivity can be adapted to the radiative efficiency of the sample. It is an advantage of particular embodiments of the present invention that the spacing between the at least one detector element and the second excitation radiation blocking means can be controlled depending on the scattering properties of the sample studied.

The shielding means may comprise at least one shielding element that is a settable shielding element allowing generation of variable shielding patterns over time. The at least one shielding element that is a settable shielding element may be the first shielding element, the second shielding element or the first and the second shielding element.

The settable shielding element allowing generation of variable shielding patterns may be a display.

It is an advantage of particular embodiments of the present invention that detection of radiation by different detector elements may be performed in an automatic and automated way.

The optical means adapted for guiding the excitation radiation aside the at least one detector element may comprise a radiation refraction means for focussing the excitation radiation aside the at least one detector element.

The radiation refraction means may comprise at least two lens elements for focussing the excitation radiation aside the at least one detector element.

The radiation refraction means may be adapted for focussing the excitation radiation on diffuse reflecting means adapted for diffusely reflecting the excitation radiation back to the sample. It is an advantage of particular embodiments of the present invention that a high fluorescence sensitivity can be obtained.

The radiation detection system furthermore may comprise a detection filter for filtering sample radiation from excitation radiation. The detection filter may be positioned in front of the at least one detector element.

The second shielding element may be positioned relative to the first shielding element such that it lies in a shadow region of the first shielding element.

The excitation radiation may be substantially collimated.

The detection system may comprise an array manufactured based on large-area electronics technologies. Large area electronics technologies may be technologies based on amorphous silicon, low temperature poly-silicon and/or organic technologies.

The present invention also relates to a method for detecting radiation from a sample, the method comprising

irradiating a sample with excitation radiation from a first side of the sample, the irradiating being irradiating for generating sample radiation,

detecting sample radiation from a second side of the sample using at least one detector element, the second side being opposite to the first side,

the method comprising guiding the excitation radiation aside the at least one detector element used for detecting the sample radiation.

Particular and preferred aspects of the invention are set out in the accompanying independent and dependent claims. Features from the dependent claims may be combined with features of the independent claims and with features of other dependent claims as appropriate and not merely as explicitly set out in the claims.

The teachings of the present invention permit the design of improved methods and apparatus for detecting radiation, such as methods and systems for fluorescence detection.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic illustration of an optical setup to detect fluorescence signals coming from a biochip according to prior art.

FIG. 2 is an illustration of the overlap between an excitation spectrum and fluorescence spectrum due to a Small Stokes shift as often occurring in bio-chemical fluorescent assays, according to prior art.

FIG. 3 is a schematic representation of a detection system comprising excitation radiation guiding means according to embodiments of the present invention.

FIG. 4a and FIG. 4b illustrate a front irradiation system for a micro-fluidic device having a double layer shielding element positioned at opposite sites of a substrate, according to embodiments of the present invention.

FIG. 5 is a schematic illustration of a mirco-fluidic radiation detection system with front irradiation and a single shielding element, according to a first embodiment of the first aspect of the present invention.

FIG. 6 illustrates unwanted irradiation of a detector element, in a front irradiation system for an optical sensing micro-fluidic device with a single shielding element, as may occur in a detection system according to the first embodiment of the first aspect of the present invention.

FIG. 7 illustrates front irradiation system for a sensing micro-fluidic device having a spatially variable shielding means, according to the second and third embodiment of the first aspect of the present invention.

FIG. 8 illustrates a front irradiation system for a micro-fluidic device having a two fixed shielding elements, according to the fourth embodiment of the first aspect of the present invention.

FIG. 9 illustrates a front irradiation system for a micro-fluidic device having two fixed shielding elements and having a collimated light source according to the fifth embodiment of the first aspect of the present invention.

FIG. 10 illustrates a front irradiation system for a micro-fluidic device having radiation refraction means according to the sixth embodiment of the first aspect of the present invention.

FIG. 11 illustrates a method for detection of radiation based on front irradiation according to the second aspect of the present invention.

In the different figures, the same reference signs refer to the same or analogous elements.

### DETAILED DESCRIPTION OF THE EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The different embodiments and aspects of the present invention relate to the detection of radiation, e.g. detection of electromagnetic radiation. The detection of radiation usually relates to emission from a sample upon excitation with an excitation beam, e.g. fluorescence emission, although the present invention is not limited thereto. The excitation radiation may comprise electromagnetic radiation in the optical, infrared, far infrared, ultraviolet or far ultraviolet wavelength ranges. The radiative emission from a sample may e.g. be radiative emission sites which may be occupied sites on a substrate occupied by e.g. luminescent labelled target particles, a technique often used in micro-fluidics bio-detection. Nevertheless, the methods and systems for detecting radiative emission from samples also may relate to detection of all kinds of radiative emission, i.e. not necessarily related to bio-particles but also to other radiative sources, such as e.g. chemical or structural features of a device, sample or surface leading to generation of light emission, e.g. when irradiated. By way of illustration, detection of radiative emission from radiative labels, e.g. luminescent labels, in a sample will be described in the following embodiments, although the invention is not limited thereto. The sample typically may be a fluid such as a liquid or gas. The sample typically may be an analyte mixture. Typical radiative processes included within the scope of the present invention are fluorescence processes, phosphorescence processes, chemiluminescence processes, photochromism processes, etc.

Detecting of radiation may be used for analysing a sample biologically, chemically or bio-chemically. Typically, such detection systems may be applied in bio-chemistry and molecular bio-physics. As current biochemistry protocols are often already incorporating fluorescent labels, chip-based assays can easily be incorporated into existing protocols without changing the biochemistry. For instance, fluorescent labelling of proteins is most common in biosciences, and millions of fluorescent immunoassays are performed worldwide every year. In addition, reactions such as Sanger sequencing and the polymerase chain reaction (PCR) have been adapted to use fluorescent labelling methods. In fact, real-time quantitative PCR amplification (RQ-PCR), which is a fast growing technology for medical diagnostics, is being performed with high efficiency using fluorescent labels. In this technology, the presence of amplified products is quantitatively recorded during temperature processing using reporter molecules (e.g. molecular beacons) that generate an optical signal that is measured in real-time in the same device. The recorded signal is a measure for the presence as well as the concentration(s) of specific nucleic acid molecules, for example (but not limited to) a bacterium or a set of bacteria. Generally, fluorescence detection can be used in a variety of applications on an analysis chip, such as the fluorescent detection of optical beacons during DNA amplification, labelled proteins and immobilized or hybridised (labelled) nucleic acids on a surface.

Typically in bio-sensing processes or related processes as described above, sensing processes using radiation detection such as e.g. luminescent detection, are based on radiative labels that are directly or indirectly attached to target molecules such as e.g. proteins, antibodies, nucleic acids (e.g. DNR, RNA), peptides, oligo- or polysaccharides or sugars, small molecules, hormones, drugs, metabolites, cells or cell fractions, tissue fractions, etc. These molecules typically may be detected in a fluid, which can be the original sample or can already have been processed before insertion into the biosensor, e.g. diluted, digested, degraded, biochemically modified, filtered, dissolved into a buffer. The original fluids can be for example, biological fluids, such as saliva, sputum, blood, blood plasma, serum, interstitial fluid or urine, lymph, anal and vaginal secretions, perspiration and semen of virtually any organism, e.g. mammalian samples and human samples, or other fluids such as drinking fluids, environmental fluids, or a fluid that results from sample pre-treatment. It may e.g. be environmental samples, such as air, agricultural, water and soil samples, biological warfare agent samples; research samples. The fluid can for example comprise elements of solid sample material, e.g. from biopsies, stool, food, feed, environmental samples. E.g. in the case of nucleic acids, the sample may be the products of an amplification reaction, including both target and signal amplification; purified samples, such as purified genomic DNA, RNA, proteins, etc.; raw samples (bacteria, virus, genomic DNA, etc.). As will be appreciated by those in the art, virtually any experimental manipulation may have been done on the sample.

In particular embodiments according to aspects of the present invention, the detection system may involve a re-usable reader system and a disposable unit in which the sample is entered. The disposable unit thereby typically is adapted to be read out by the re-usable reader system. Different components of the detection system may be part of the re-usable reader device or may be part of the disposable cartridge. E.g. the excitation radiation source, the sample measurement region in a measurement chamber, typically comprising a substrate with binding sites, the optical components and the detector element(s) may be part of the disposable cartridge. The present invention is especially useful in such disposable detection systems as it provides an alternative for the use of expensive high quality filters for separating the excitation radiation and the radiative emission stemming from the sample.

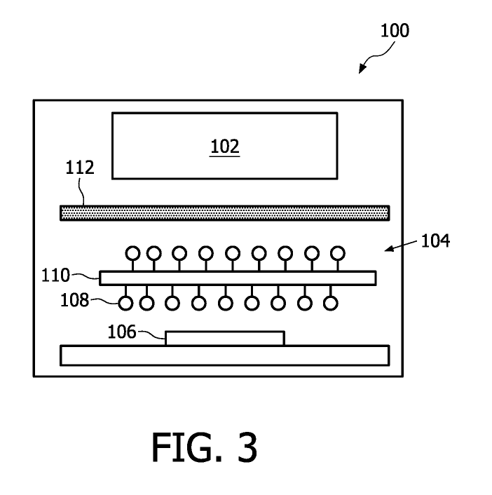

In a first aspect, the present invention relates to radiation detection systems adapted for detecting radiation, e.g. a luminescent signal from a sample, thus allowing quantitative and/or qualitative analysis of the sample, e.g. the presence of a specific component in the sample. A schematic representation of embodiments according to the first aspect of the present invention is shown in FIG. 3. It shows a radiation detection system 100 which may comprise an excitation radiation source 102 and which comprises a sample measurement region 104 in a measurement chamber adapted for receiving excitation radiation and at least one detector element 106. The sample measurement region 104 can take the form of a chamber or substrate with sample sites located therein or thereon. These sites may emit electromagnetic radiation to be detected. Alternatively, the measurement chamber comprising the measurement region may comprise a fluid which further comprises the sample—for example in the form of particles in the fluid—that may emit electromagnetic radiation to be detected. Such detection systems may enable optical detection of radiative signals emerging from the sample, e.g. fluorescent signals, in a micro-fluidic device such as a bio-sensor or a PCR reaction chamber.

The excitation radiation source 102, may be any suitable excitation source for exciting radiation from the target particles, e.g. target molecules labelled with luminescent labels. Such excitation radiation source 102 may generate any suitable electromagnetic radiation, e.g. electromagnetic radiation in the optical, infrared, far infrared, ultraviolet or far ultraviolet wavelength ranges, although the invention is not limited thereto. Typical excitation radiation sources 102 may be collimated and non collimated radiation sources. The excitation radiation sources 102 may e.g. be light emitting diodes (LED), laser systems or any other type of excitation radiation source allowing to provide radiation, e.g. electromagnetic radiation for exciting the sample or particles thereof. For example, in the case where the excitation radiation is electromagnetic radiation generating an optical luminescence response, the optical wavelength of the excitation radiation typically may be e.g. in the range from 200 nm to 2000 nm, or e.g. in the range from 400 nm to 1100 nm, the invention not being limited thereto. The excitation radiation source 102 may be part of the radiation detection system 100, as shown in FIG. 3, or may be external to the radiation detection system 100. The excitation radiation source 102 may provide irradiation of the full region to be irradiated at once or may provide scanning irradiation. It may be a pulsed source or a continuous source.

The measurement region 104 in a measurement chamber provided in the detection system 100 typically is adapted for receiving at least one sample 108. The measurement region 104 thus typically is the region wherein at least one sample 108 can be analysed. The measurement region 104 typically is located in a measurement chamber. The measurement chamber may be part of the radiation system, but the invention is not limited thereto. Such analysis in the present invention typically may be detection of radiation obtained by exciting the sample 108 or part thereof using excitation radiation. The at least one sample 108 typically therefore may comprise radiative sites or centers, excitable by excitation radiation. Such radiative sites or centers may be for example luminescent labels in a microfluid that are coupled to or that are part of target molecules to be detected. Examples of samples that may be studied according to embodiments of the present invention, as well as specific examples of the use of luminescent labels are discussed in more detail above. The measurement region 104 in a measurement chamber may comprise a substrate 110 for binding the sample. The surface of the substrate 110 may be modified by attaching molecules to it, which are suitable to bind the target molecules which are present in the fluid. The surface of the substrate 110 can also be modified in any other suitable way. If present, the substrate typically needs to be transparent. Depending on at which side the sample is located, this transparency needs to be for the excitation radiation, the generated sample radiation or for both. Alternatively or in combination therewith, a surface suitable to bind the target molecules to it also may be provided on another surface, different from the additional substrate 110, of the detection system. The sample 108 also may be present in the measurement region 104 in a measurement chamber in any suitable alternative way, e.g. not bound to a surface but suspended in a fluid. The above may be applied, for example, in real-time quantitative PCR amplification (RQ-PCR), which is a fast growing technology for medical diagnostics, whereby detection is performed with high efficiency using fluorescent labels. In this technology, the presence of amplified products is quantitatively recorded during temperature processing using reporter molecules (e.g. molecular beacons) that generate an optical signal that is measured in real-time in the same device. The recorded signal typically is a measure for the presence as well as the concentration(s) of specific nucleic acid molecules, for example (but not limited to) a bacterium or a set of bacteria.

The measurement region 104 in a measurement chamber furthermore is adapted for receiving excitation radiation from a first side of the measurement region 104 in a measurement chamber. Such excitation radiation may e.g. be generated by the excitation radiation source 102, or it may be any excitation radiation present from another source and suitable for exciting the sample 108 or components thereof.

The at least one detector element 106 of the detection system 100 may be any type of detector element suitable for detecting radiation from the sample 108 or components thereof, generated by excitation radiation. Which detector element 106 is to be used depends on the type of radiation generated in the sample or components thereof. Typical examples of detector elements 106 that may be used for example in case of optical fluorescence radiation is generated in the sample or components thereof are e.g. a microscope, a camera such as a CCD or CMOS camera, an optical detector, a photo-detector, such as e.g. a photo diode, a photo transistor or an array thereof. At least one detector element 106 may be one detector element or may be a plurality of detector elements. If a plurality of detector elements are present in the detection system 100, the detector elements may be spaced apart from each other. The plurality of detector elements may be positioned in a single plane. The detector elements thus may have regions aside them where no detector element is present.

According to embodiments of the present invention, the at least one detector element 106 is positioned at a second side of the measurement region 104 in a measurement chamber which is opposite to the first side of the measurement region 104 in a measurement chamber from which the measurement region in a measurement chamber, in operation, receives the excitation radiation. In other words, the at least one detector element 106 is positioned at the side opposite to the receiving side for the excitation radiation with respect to the measurement region 104 in a measurement chamber. The excitation radiation is incident from the side of the detection system 100 facing the at least one detector element 106.

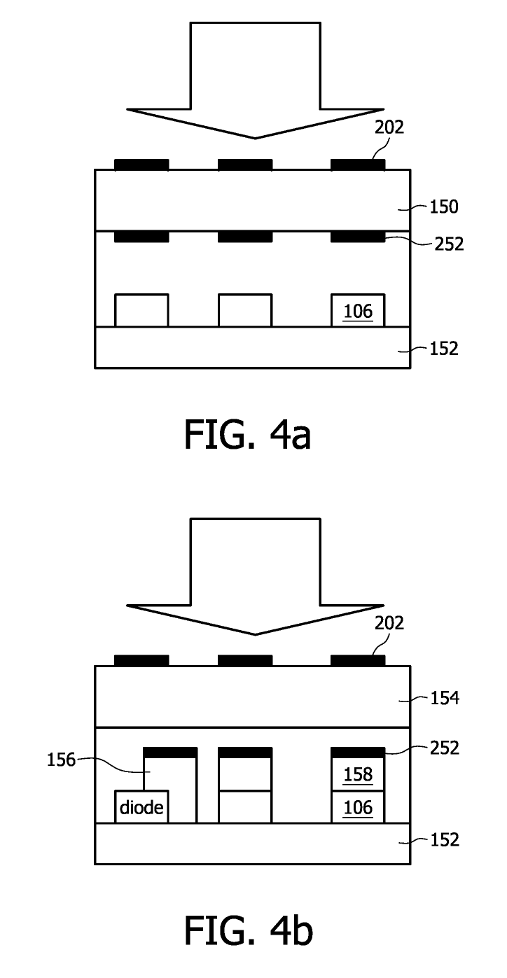

According to embodiments of the present invention, the detection system 100 furthermore comprises optical means 112 adapted for guiding the excitation radiation aside the at least one detector element 106, also referred to as an excitation radiation guiding means 112. The excitation radiation guiding means 112 may furthermore reduce excitation radiation impinging on the at least one detector element 106. The means may furthermore be adapted for guiding stray light aside the at least one detector element 106. The excitation radiation guiding means 112 in some embodiments of the present invention may comprise shielding means for shielding excitation radiation from being impingent on the at least one detector element 106. These shielding means may comprise one or more shielding elements adapted for reducing excitation radiation impinging on the at least one detector element 106, or if a plurality or detector elements are present, for reducing excitation radiation impinging on at least a subset of the detector elements. The position of the shielding means may be adaptable, e.g. as well in a direction of the plane substantially determined by the shielding means as in a direction perpendicular thereto, to adapt the shielding properties for different detector elements or to adapt to scattering properties of the sample that is measured. The shielding means thus typically also is adapted for guiding excitation light aside the at least one detector element 106. In case a plurality of detector elements are present, the shielding means may be adapted for guiding excitation radiation in between said detector elements 106. The shielding means may substantially attenuate excitation radiation that would impinge on the at least one detector element 106, e.g. by scattering the light or preferably by absorbing or reflecting the excitation radiation. Moreover, the shielding means may substantially attenuate all radiation, i.e. both the excitation radiation and the resulting generated radiation from the sample, that would impinge on the at least one detector element 106, e.g. by scattering the light or preferably by absorbing or reflecting the radiation. The latter may be obtained by making the shielding means absorbing, e.g. black for optical radiation, or reflecting, e.g. by making it in metals, preferably metals with a high reflection coefficient for the excitation radiation used. Depending on the radiation used, such metals may e.g. be aluminium, silver, chromium, etc. Providing shielding means may be realised in different ways. The shielding means may for example be applied to an additional substrate or may be provided to, if present, the substrate adapted for receiving the sample, or may be provided to other layer applied to the detector elements. In the following, realisation of a shielding means comprising two different shielding elements will be illustrated by way of example. The examples are illustrated for collimated light, although the concept of realising the shielding means also applies to non-collimated light, albeit typically with a different shielding pattern provided by the shielding means. For example, two shielding elements 202, 252 may be realised on opposite sides of a transparent substrate 150 as shown in FIG. 4a, or alternatively one shielding element 252 could be realised upon a substrate 152 comprising the detector element and the second shielding element 202 layer on a further substrate 154, which may be the substrate used for binding the sample, as shown in FIG. 4b. In the latter case, the shielding element 252 could—the invention not being limited thereto—for example be separated from the sensors using either a transparent spacer 156, shown here in the general case positioned offset in the lateral direction, but for the case of collimated light preferably positioned directly above the sensor, such as a photo-resist layer, or alternatively using a material 158 which could further serve as filter layer. The latter would work well if the spacer layer completely covers the sensor, as shown for two of the detector elements 106 shown on the right hand side of FIG. 4b. A number of specific embodiments wherein the excitation guiding means 112 comprise shielding means will be discussed later in more detail.

The excitation guiding means 112 in some embodiments may comprise radiation refracting means for guiding the excitation radiation aside the at least one detector element. In the latter case, the radiation refracting means focus the excitation radiation substantially aside the at least one detector element 106, thus reducing excitation light impinging on the at least one detector element 106. When a plurality of detector elements are present, the refracting elements typically are adapted to focus the light in areas between the detector elements, the latter typically being spaced from each other. The radiation refracting means may e.g. be an array of micro-lenses, the invention not being limited thereto. A number of specific embodiments will be discussed later in more detail.

Although in embodiments according to the present invention, excitation radiation impinging on the detector elements 106 is reduced, analysis of the sample 108 still is possible, as typically the excited sample or sample components are radiative in different directions, e.g. all directions, such that the generated sample radiation is able to reach the at least one detector element.

In embodiments according to the present invention, the direct irradiation, and possibly also the indirect irradiation of the detector elements 106 with excitation radiation is sufficiently suppressed to allow good detection of the generated sample radiation, although the generated sample radiation intensity typically may be substantially weaker than the initial excitation radiation intensity created by the source.

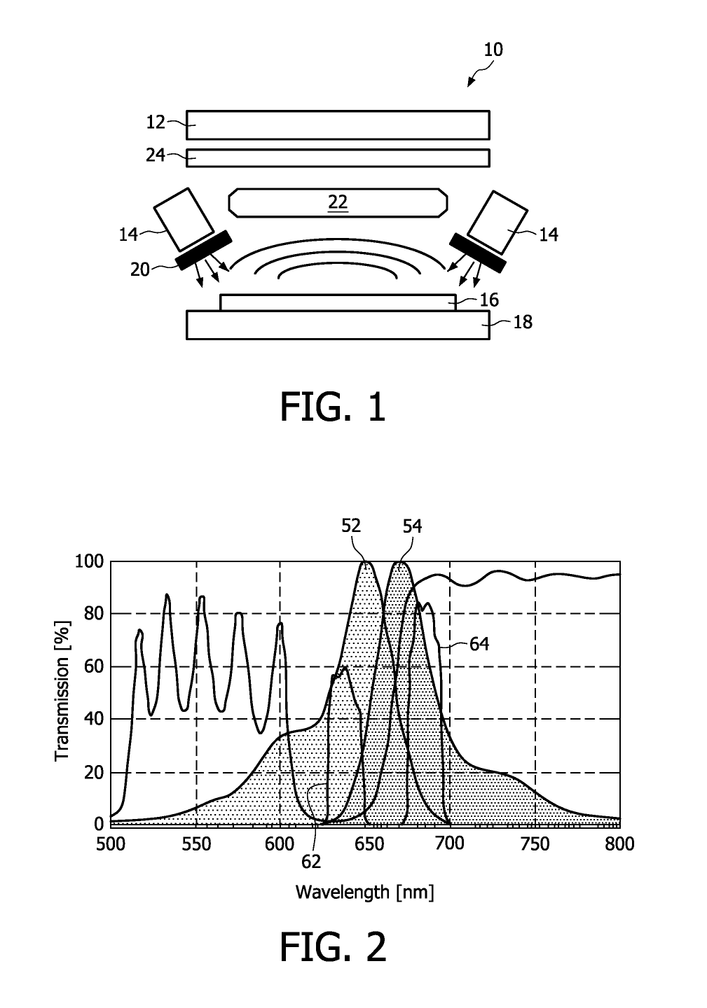

Although filters still may be used on top of the at least one detector element 106 to selectively allow generated sample radiation in the detector element(s) and block excitation radiation, the latter is not strictly needed to obtain a sufficient signal/noise ratio. This results in the advantage that cost expensive filters, both economically and labour-intensive, can be avoided. Nevertheless, such optical filters (not shown in FIG. 3), e.g. dichroic filters, typically positioned above the detector element(s) 106, may be applied to further suppress the excitation radiation incident on the detector element(s) whilst allowing the generated sample radiation to pass. The filters may be of substantially lower quality, and hence substantially lower cost, than those used in the configurations of FIGS. 1 and 2. Furthermore, the excitation radiation source 102 may also comprise an excitation filter (not shown in FIG. 3) to further enhance the performance of the system by avoiding additional non-appropriate radiation from the excitation radiation source 102.

It is an advantage of embodiments of the present invention that the sample supporting the at least one detector element 106 may be non-transparent, such as e.g. a metal or semiconductor substrate. The substrate also may be flexible.

The above described first aspect of the present invention will now be further illustrated using different embodiments, illustrating different advantages that may be obtained. Where applicable, features of the different embodiments may be combined.

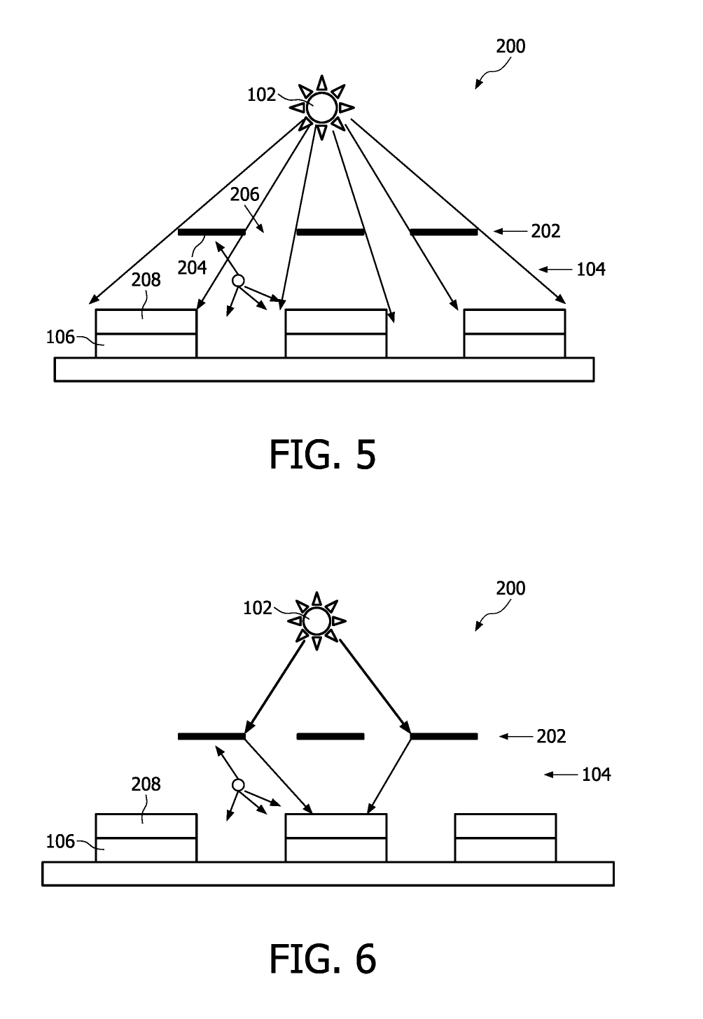

In a first embodiment according to the first aspect of the present invention, a detection system 200 comprising the same features, having the same options and the same advantages as described above, but whereby the excitation radiation guiding means comprises a shielding means with a single shielding element 202 to suppress the intensity of the excitation radiation on the at least one detector element 106 is desired. An exemplary system is shown in more detail in FIG. 5. The system shows an excitation radiation source 102, a measurement region 104 in a measurement chamber, at least one detector element 106 and the single shielding element 202. The single shielding element 202 thereby may be a single layer radiation shield. It may be shaped and positioned such that substantially no direct impingement of radiation on the detector elements 106 is possible. The latter is obtained by providing a shielding portion 204, i.e. a scattering portion, absorbing portion, reflecting portion or a portion combining absorbing and reflecting properties in the shielding element at positions where excitation radiation passes that otherwise could reach the at least one detector element directly, i.e. at places where a single line connection between the excitation radiation source and the at least one detector element exists. The shielding element furthermore typically may comprise non-shielding portions 206, i.e. non-attenuating or substantially non-attenuating portions in the shielding element, at locations where no excitation radiation passes that could directly reach the at least one detector element 106. The non-shielding portions may be made of non-attenuating material or may be portions where no material is provided. Alternatively the single shielding element may consist of a number of separate sub-shields lying in a single plane.

With “reaching the at least one detector element directly” there is referred to the situation where the radiation path from the excitation radiation source to the at least one detector element or from the external radiation source via the place of entry of the excitation radiation in the detection system to the at least one detector element 106 is a single line, and no change in direction of the excitation radiation path is present. E.g. in the case of fluorescence measurements, the single shielding element 202 may be a single layer optical shield, adapted to reduce excitation light from the excitation light source directly incident on the at least one detector element. The shield may be formed from absorbing materials or reflecting materials or a combination thereof. In FIG. 5, the situation is shown for a non-collimated light source, although the system also can be applied for a collimated light source. In the latter case the exact position of shielding and non-shielding portions will be positioned differently, in order to allow to shield the detector element(s) from direct impingement.

In the present embodiment, the system operates by reducing the amount of excitation radiation falling onto the at least one detector element 106 by shielding it from the excitation radiation using shielding means, whilst allowing the excitation radiation to excite excitable sample material, situated e.g. between the shielding means and the detector element(s), in the remaining liquid. As the generated sample radiation is emitted in all directions, a considerable portion of the generated sample radiation will fall onto the detector element. In this manner, a considerable gain in signal to noise ratio may be achieved. FIG. 5 furthermore illustrates the use of optional filters 208 used to further reduce the intensity of excitation radiation detected by the at least one detector element 106.

In a second and third embodiment according to the first aspect, the present invention relates to a detection system as described in the first embodiment according to the first aspect, but wherein the shielding means comprises at least two shielding elements 202, 252. By using at least two shielding elements 202, 252, the problem of unwanted detection of excitation radiation stemming from reflection of the excitation radiation at the edges of a single shielding element is addressed. There may be no sample present between the two shielding elements 202, 252. E.g. a transparent substrate, e.g. glass substrate, may be present between the two shielding elements 202, 252. The use of two shielding elements thus provides an improved suppression of unwanted detection of excitation radiation. The problem of reflection of excitation radiation at a single shielding element 202 is illustrated in FIG. 6. In the second and third embodiment, this problem thus is overcome by providing a shielding means comprising at least two shielding elements 202, 252.

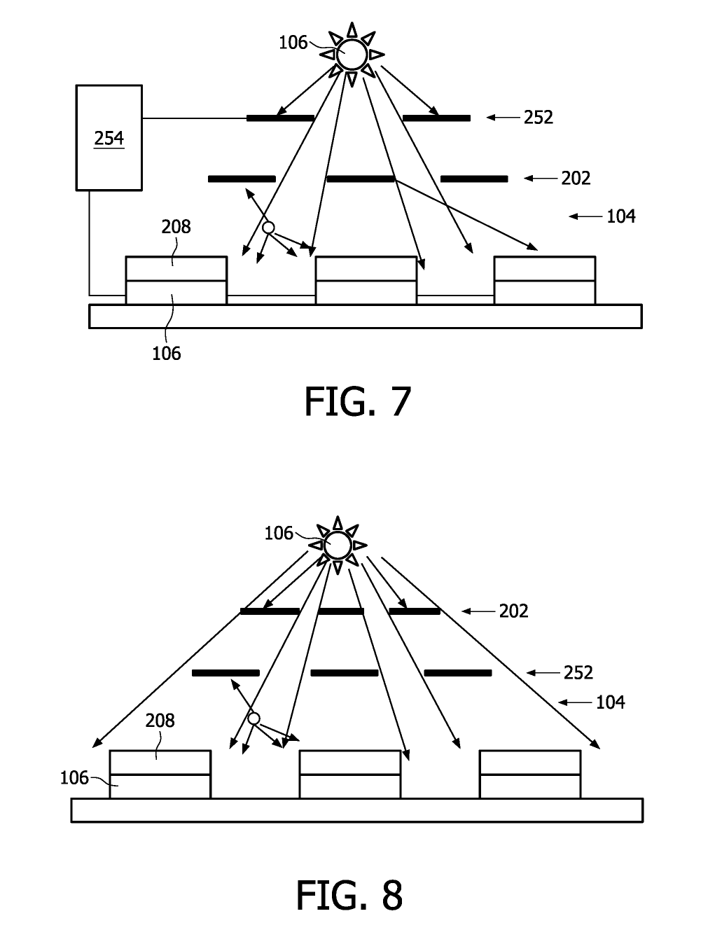

In the second embodiment, the second shielding element 252 may be positioned between the first shielding element 202 and the excitation radiation source 102 (or the point of entry of the excitation radiation in the detection system), as illustrated in FIG. 7. In this case, the second shielding element 252 is positioned so as to suppress the reflections from the excitation radiation at the edges of the first shielding element 202 as indicated in FIG. 6, whereby less reflected excitation radiation from the excitation radiation source 102 reaches the central detector element 106. This will increase the signal to noise ratio of the detector element. As can be seen in FIG. 7, for the present position of the second shielding element 252, unwanted reflections of excitation radiation still are able to reach other detector elements, e.g. in the present illustration excitation light reflected at the first shielding element 202 still may reach the detector element at the right hand side of the detection system shown in FIG. 7. In the second embodiment, the latter may be solved by controlling the activation and detection action of detector elements as a function of the position of the shielding portions of the second shielding element 252. In other words, in the second embodiment, the second shielding element 252 may be a spatially variable second shielding element 252, allowing to vary the position of the shielding portions of the second shielding element 252. For a first spatial position of shielding portions of the second shielding element 252 at least a first detector element that is substantially shielded from unwanted reflections of excitation radiation is activated while at least a second detector element that is not substantially shielded from unwanted reflections of excitation radiation is not activated. Subsequently, the spatial position of the shielding portions of the second shielding elements 252 may be altered such that detectors previously not shielded from unwanted reflections of excitation radiation now become shielded while detectors previously shielded may become not shielded. Detection using the previously non-shielded detector elements may then be performed. Several of these steps may be performed such that each detector element may be used for detection, albeit at a different timing.

A spatially variable second shielding element may be a shielding element 252 with fixed shielding portions with respect to the second shielding element 252, whereby the second shielding element 252 is moveable. The second shielding element 252 may be controllably moveable. Such movements may be performed in a lateral direction, i.e. in a direction in the plane of the shielding element. Alternatively, the position of the second shielding element 252 may be fixed, but the second shielding element 252 may be a settable shielding element 252, such that different positions of the shielding portions or non-shielding portions may be provided over time. Such a settable shielding element 252 may be e.g. based on a transmissive display device, such as e.g. a liquid crystal display. By providing a specific pattern to the settable shielding element, a specific shielding pattern may be provided, which may be changed over time by changing the pattern on the settable shielding element, e.g. by writing a different setting for the different pixels of a display device. Alternatively, such a settable shielding element could be used in a single shielding element approach, whereby the shielding pattern is adjusted until a desired signal or background level is achieved.

The problem of additional reflections thus may in the second embodiment be solved by controlling the spatial position of shielding portions of the second shielding element 252 in combination with an appropriate activation of the detector elements 106. In the second embodiment, the detection system may be provided with a controller 254 adapted for controlling the spatial position of the shielding portions of the second shielding element 252 and the corresponding activation of the different detector elements 106. Controlling the spatial position of the shielding portions of the second shielding element 252 thereby may comprise either setting the shielding pattern on the settable shielding element or moving the second shielding element in position.

In the third embodiment of the first aspect, a detection system as described in the second embodiment of the first aspect is described, comprising the same features and advantages, but wherein additional reflections of excitation radiation are avoided by the specific pattern applied for the different shielding elements 202, 252. In the third embodiment of the first aspect, the size and the position of the shielding portions of the shielding element closer to the detector elements, e.g. the second shielding element 252, are selected such that the complete shielding portions are localised within the shadow region created by a shielding element further away from the detector elements 106, e.g. the first shielding element 202. In other words, the shielding portions of the shielding element 252 closer to the detector elements cannot be directly irradiated with the excitation radiation, but only shields excitation radiation impinging on it after reflection, e.g. after reflection at the edges of the shielding portions of the shielding element 202 further away from the detector elements 106. The latter is illustrated in FIG. 8. Such a selection of the shielding elements 202, 252 results in substantially no excitation radiation being incident on the detector elements 106 and in the possibility to activate all detector elements at the same time. The amount of excitation radiation reaching the sample and allowing excitation may be smaller than in the second embodiment.

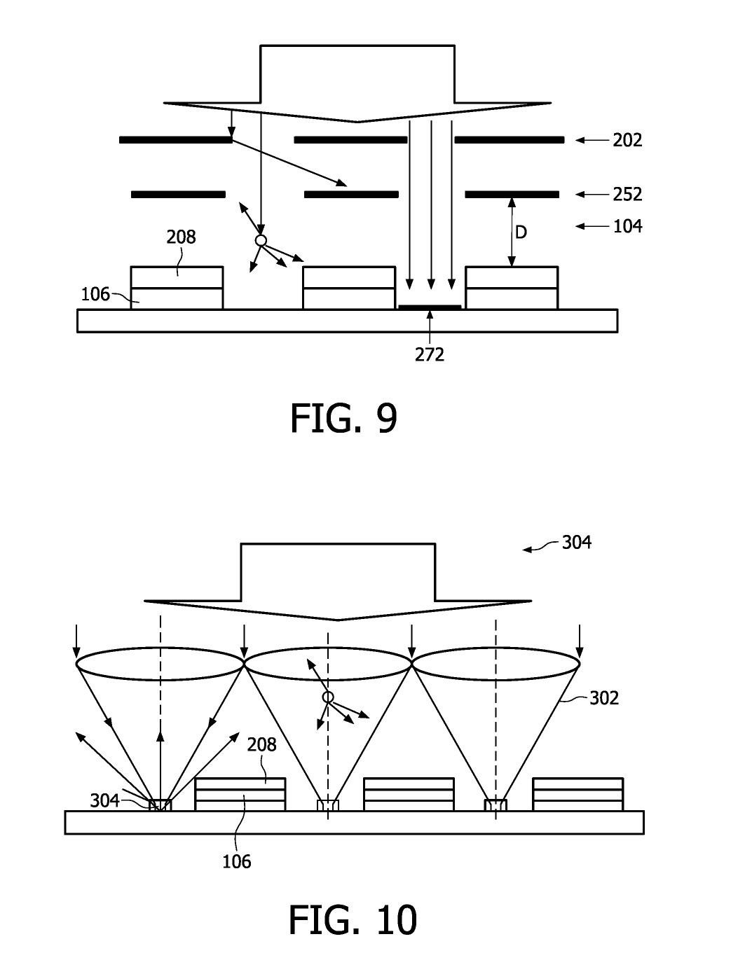

In a fourth embodiment according to the first aspect, the present invention relates to any of the previous embodiments comprising the same features and having the same options and advantages, but wherein the excitation radiation source is collimated, such that the initial direction of incidence of the excitation radiation is perpendicular to the shielding means. The latter is illustrated by way of example in FIG. 9. FIG. 9 indicates a shielding means with two shielding elements 202, 252 as described in the third embodiment, whereby the reflections at all edges of the shielding portions of the shielding element 202 closest to the excitation radiation source 102 are suppressed from the detector elements 106 by a second shielding element 252 with shielding portions in the shadow of the first shielding element 202. In this manner no reflected excitation radiation from the excitation source reaches any of the detector elements 106. This increases the signal to noise ratio of all detector elements 106, which, in the present example, may be activated simultaneously. In the fourth embodiment according to the first aspect, in case a plurality of detector elements 106 are used, an optical absorbing means or anti-reflecting means 272 may be provided in between the plurality of detector elements 106, to reduce unwanted reflections of excitation radiation that is guided aside the detector elements 106. The latter again allows increasing the signal to noise ratio. Such an optical absorbing means or anti-reflecting means 272 is shown by way of example in FIG. 9.

In a fifth embodiment of the first aspect, the present invention relates to a detection system according to any of the previous embodiments, comprising the same features and having the same options and advantages, whereby the distance between the shielding element closest to the at least one detector element can be varied. The latter also is indicated in FIG. 9. The distance between the shielding element 252 closest to the at least one detector element, i.e. the separation D, is a measure for the amount of generated sample radiation that may be generated by the excitation radiation and that is detectable by the at least one detector element 106. The further the closest shielding element 252 is positioned from the at least one detector element 106, the more excitable sample or sample components may be present between the closest shielding element 252 and the at least one detector element 106 resulting in more generated sample radiation that may be detected by the detector elements 106. The separation D may be dependent on the optical scattering properties of the fluid, whereby the separation D preferably may be reduced if the scattering properties of the fluid increase.

In other words, by varying the separation between the closest shielding element 252 and the at least one detector element 106, the volume of fluid being optically excited can be maximised. For example, in case the latter is applied for a collimated excitation radiation source 102, the chance of direct irradiation of the detector element(s) 106 from scattered excitation radiation from the collimated excitation radiation source 102 can become a problem, especially as the separation increases and the degree of scattering increases. In this case, reducing the distance between the closest shielding element 252 and the detector elements 106 may reduce the problem of scattered light impinging on the detectors. The same considerations hold for the case of a non-collimated light source, where again scattering may cause unwanted light impinging on the detectors.

In a sixth embodiment of the first aspect, the present invention relates to a detection system as described above, wherein the excitation guiding means 112 that is adapted for guiding the excitation radiation aside the at least one detector element 106 comprises radiation refractive means. Such a detection system 300 is illustrated in FIG. 10. The radiation refractive means 302 may e.g. be a lens array, positioned between the at least one detector element 106 and the excitation radiation source 102. The radiation refractive means 302 reduces direct irradiation of the detector element(s) 106 with the excitation radiation by guiding the excitation radiation aside the detector element(s) 106. In case a plurality of detector elements 106 are used, the excitation radiation is guided in between the detector elements 106. The latter is obtained by the radiation refractive means 302 focussing the excitation radiation aside the at least one detector element 106 or in between detector elements 106. This allows to increase the size of the detector elements 106 compared to previous embodiments, without radiation refraction means. The latter allows that the generated sample radiation collection efficiency may increase. Preferably, the radiation refraction means 302, e.g. lenses in a micro-lens array, have a high numerical aperture, allowing to irradiate a larger volume of the sample located above the detector element(s) 106.

Optionally, the radiation refraction means 302 may focus the excitation radiation on a diffuse reflecting means 304. Such a diffuse reflecting means 304 may be e.g. a diffuse reflecting film or a diffuse scattering surface, the invention not being limited thereto. The excitation radiation impinging on the diffuse reflecting means 304 may then typically be again directed through the sample, whereby the generated sample radiation is increased. In this way, the efficiency for detecting generated sample radiation will increases further. In order to avoid that the radiation refraction means 302 reflects the diffusively reflected excitation radiation back towards the detector elements, an anti-reflective coating may be applied to the radiation refraction means 302. Again, in this manner no reflected excitation radiation reaches any of the detector elements, thus increasing the signal to noise ratio of all detector elements 106, which may be activated simultaneously.

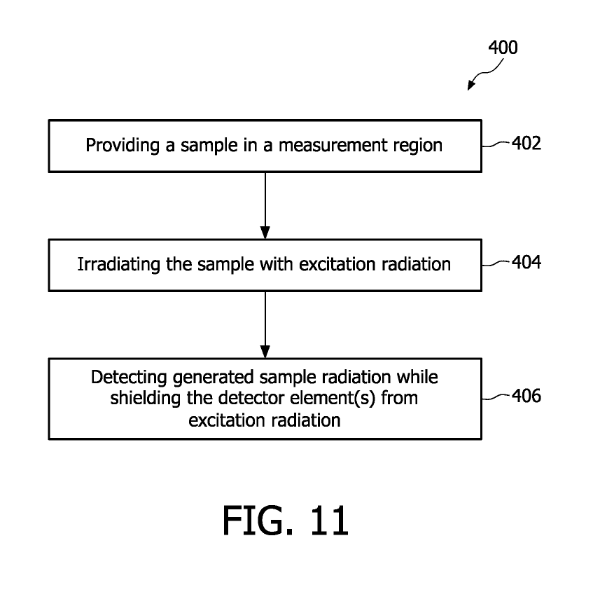

In a second aspect, the present invention relates to a method for detecting generated sample radiation from a sample excited with excitation radiation. The method typically may comprise providing a sample in a measurement region in a measurement chamber. The method according to the present invention comprises irradiating the sample with excitation radiation, thus creating generated sample radiation to be detected, and detecting the generated sample radiation with at least one detector element while further guiding the excitation radiation aside the at least one detector element. Irradiating and detection thereby is done at different sides of the sample, i.e. a front irradiation method is used. Such a method 400 is further illustrated by way of example in FIG. 11, showing standard and optional steps of an exemplary method for radiation detection.

In a first step 402, a sample is provided in a measurement region of a detection system. The latter may comprise filling a measurement region in a measurement chamber with sample. Often in micro-fluidic tests, a contacting step between an analyte mixture to be analysed and a substrate comprising capturing probes may be performed as well as a washing step to remove lightly bounded elements. These steps are known from prior art, are specific for bounded radiative labels and will not be discussed in detail further. The first step 402 may be part of the method or may be optional.

In a second step 404, the sample is irradiated with excitation radiation. Such radiation may stem from an excitation radiation source external to the detection system or an excitation radiation source which is part of the detection system. Irradiating the sample typically is performed for exciting radiative particles in the sample. The latter may e.g. be luminescent or fluorescent labels, bounded to target molecules or may be luminescent or fluorescent particles comprising the target molecules. Such irradiation may be performed in a continuous mode, in a pulsed mode, in a scanning mode, in a multiplexing mode allowing differently excitable labels to be excited at the same time, a combination thereof or in any other suitable way.

In a third step 406, which typically is performed in substantially the same time period as the second step 404, the radiative response from the sample, it is the radiation originating from radiative particles in the sample, is detected. The latter is performed while guiding the excitation radiation aside the at least one detector element used. Guiding the excitation radiation aside the at least one detector element used may comprise shielding the at least one detector element from directly impinging excitation radiation and/or shielding the at least one detector element from excitation radiation impinging after reflection, e.g. at edges of the shields used. Guiding the excitation radiation aside the at least one detector element also may comprise focussing the excitation radiation aside the at least one detector element. The latter may for example be obtained by refracting the excitation radiation. Detection is performed from the side of the sample opposite to the side of the sample where the excitation radiation initially is impinging, in other words a front irradiating method is used.

In particular embodiments of the second aspect, shielding the at least one detector element from direct impingement by excitation radiation may be performed by using a first shielding means and a second shielding means. In particular embodiment of the second aspect, shielding the at least one detector element may comprise controlling the activation of different detector elements and controlling the spatial position of shielding portions of at least one shielding device such that for each detector element, during the activation and detection time the spatial position of the shielding portions of the at least one shielding element are adapted to block excitation radiation from that detector element. The latter may comprise amending the spatial position of the shielding portions of the at least one shielding device over time, depending on the detector element that is to be activated and used for detection. Amending the spatial position of the shielding portions of the at least one shielding device may comprise moving the at least one shielding device or setting the at least one shielding element, if the shielding element is a settable device allowing setting of the shielding pattern of the device.

Detection systems as described in embodiments of the first aspect may be suitable to be used in methods according to embodiments of the second aspect.

In particular embodiments of the second aspect, shielding the at least one detector element also may comprise adapting a distance between a shielding element and the at least one detector element in order to adapt to the scattering efficiency of the sample under study.

In embodiments according to the present invention, the detection systems may incorporate as a component an array based on active matrix principles. Such a device is preferably fabricated from one of the well-known large area electronics technologies, such as amorphous silicon (a-Si), low temperature poly silicon (LTPS) or organic technologies. A TFT, diode or MIM (metal-insulator-metal) could be used as active element. The active matrix technology is used in the field of flat panel displays for the drive of many display effects e.g. LCD, OLED and electrophoretic displays. It provides a cost-effective method to fabricate a disposable biochemical module. This is advantageous, as biochips, or alike systems, may contain a multiplicity of components, the number of which will only increase as the devices become more effective and more versatile.

Other arrangements for accomplishing the objectives of the detection system embodying the invention will be obvious for those skilled in the art.

It is to be understood that although preferred embodiments, specific constructions and configurations, as well as materials, have been discussed herein for devices according to the present invention, various changes or modifications in form and detail may be made without departing from the scope and spirit of this invention. For example, whereas embodiments of the present invention have been illustrating detection systems and methods for detecting, the present invention also relates to a controller as described in the second embodiment of the first aspect.

1. A radiation detection system (100) comprising a measurement region (104) in a measurement chamber adapted for receiving at least one sample (108) to be examined and for receiving excitation radiation for impingement on said at least one sample (108) and for generating sample radiation, the radiation detection system (100) also comprising at least one detector element (106) for detection of the generated sample radiation,
the excitation radiation being incident on a first side of the measurement region (104) in a measurement chamber and the at least one detector element (106) being positioned at a second side of the measurement region (104) in a measurement chamber, the second side being opposite to the first side with respect to the measurement region (104) in a measurement chamber,
wherein the detection system (100) furthermore comprises optical means (112) adapted for guiding said excitation radiation aside the at least one detector element (106).

2. A radiation detection system (100) according to claim 1, wherein the optical means (108) comprise shielding means adapted for substantially shielding the at least one detector element (106) from said excitation radiation.

3. A radiation detection system (100) according to claim 2, wherein the shielding means comprises a first shielding element (202) adapted for substantially shielding direct impingement of excitation radiation on the at least one detector element (106).

4. A radiation detection system (100) according to claim 3, wherein the shielding means furthermore comprises a second shielding element (252) adapted for substantially blocking at least part of said excitation radiation scattered by said first shielding element (202).

5. A radiation detection system (100) according to claim 2, the shielding means comprising at least one shielding element (202, 252) that is controllably moveable with respect to said at least one detector element (106).

6. A radiation detection system (100) according to claim 5, wherein said shielding element (202, 252) being controllably moveable is moveable within a plane determined by said shielding element (202, 252).

7. A radiation detection system (100) according to claim 5, the detection system comprising a plurality of detector elements and furthermore comprising a controller for correlating a movement of said controllably moveable shielding element (202, 252) with an activation of each of said plurality of detector elements.

8. A radiation detection system (100) according to claim 5, wherein said shielding element (202, 252) being controllably moveable is moveable in a direction perpendicular to a plane determined by said shielding element (202, 252)

9. A radiation detection system (100) according to claim 2, the shielding means comprising at least one shielding element (202, 252) that is a settable shielding element allowing generation of variable shielding patterns over time.

10. A radiation detection system (100) according to claim 9, wherein the settable shielding element allowing generation of variable shielding patterns is a display.

11. A radiation detection system (100) according to claim 1, wherein the optical means (108) adapted for guiding said excitation radiation aside the at least one detector element (106) comprise a radiation refraction means (302) for focussing said excitation radiation aside the at least one detector element (106).

12. A radiation detection system (100) according to claim 11, said radiation refraction means (302) comprising at least two lens elements for focussing said excitation radiation aside said at least one detector element (106).

13. A radiation detection system (100) according to claim 11, wherein said radiation refraction means (302) is adapted for focussing said excitation radiation on diffuse reflecting means (304) adapted for diffusely reflecting said excitation radiation back to the sample (108).

14. A radiation detection system (100) according to claim 1, wherein said radiation detection system furthermore comprises a detection filter for filtering sample radiation from excitation radiation.

15. A radiation detection system (100) according to claim 4, wherein the second shielding element (252) is positioned relative to the first shielding element (202) such that it lies in a shadow region of said first shielding element (202).

16. A radiation detection system (100) according to claim 1, wherein the excitation radiation for impingement on said at least one sample (108) is substantially collimated.

17. A radiation detection system (100) according to claim 1, wherein the detection system (100) comprises an array produced by large-area electronics technologies.

18. A method (400) for detecting radiation from a sample, the method comprising
irradiating (404) a sample with excitation radiation from a first side of said sample, said irradiating being irradiating for generating sample radiation
detecting (406) sample radiation from a second side of said sample using at least one detector element, said second side being opposite to said first side, said method comprising guiding said excitation radiation aside the at least one detector element used for detecting said sample radiation.
